(19) United States
(12) Patent Application Publication
(10) Pub. No.: US 2024/0286150 A1
(43) Pub. Date: Aug. 29, 2024

(54) DUAL-PORT SHOWERHEAD FOR USE IN RECIRCULATING SHOWERS

(71) Applicant: PLEDGE RESOURCE MANAGERS INC. DBA RAINSTICK SHOWER, Kelowna (CA)

(72) Inventors: Sean MCFETRIDGE, Kelowna (CA); Alisha MCFETRIDGE, Kelowna (CA)

(21) Appl. No.: 18/693,226

(22) PCT Filed: Sep. 22, 2022
(86) PCT No.: PCT/CA2022/051411

§ 371 Date: Mar. 19, 2024

Related U.S. Application Data
(60) Provisional application No. 63/246,819, filed on Sep. 22, 2021.

(51) Int. Cl. B05B 1/18; B05B 12/14; B05B 14/00; E03C 1/04

(52) U.S. Cl. CPC B05B 1/185; B05B 12/1472; B05B 14/00; E03C 1/0408

(57) ABSTRACT

The disclosure is directed at a dual-port showerhead that includes a set of openings for receiving water from a first water supply and a second water supply. The openings are associated with separate water collection cavities that keep the water from the two water supplies separate such that they do not mix.

### CROSS-REFERENCE TO OTHER APPLICATIONS

The current disclosure claims priority from U.S. Provisional Application No. 63/246,819 filed Sep. 22, 2021, which is hereby incorporated by reference.

### FIELD

The current disclosure is generally directed at shower fixtures and more specifically, at a dual-port showerhead for use in recirculating showers.

### BACKGROUND

Approximately 10% of all water required for human activity on Earth can be traced back to residential consumption needs. In our homes, as much as 40% of water consumed indoors originates in the bathroom with showers leading as a top contributor to water use.

Solutions to limit water consumption through limiting flow have become increasingly common and are often controlled through building code restrictions. Although this remains a cheap and cost effective approach to water conservation; flow reduction through the showerhead has forced users to compromise on experience. Due to these restrictions, this “low-flow” solution often applies flow limits to showerheads thereby restricting the flow pressure. These tightening regulations have caused homeowners to reconsider the re-use and recirculation of shower water at the source, also referred to as point-of-use.

In order for a recirculating shower appliance to comply with local, regional and/or national guidelines, it must overcome two issues. The first is compliance with building code limitations placed on the showerhead's flow rate. The second is avoidance of recirculation water potentially “back-flowing” into the municipal grid supply due to pressure imbalances between the recirculating shower and the grid supply.

Therefore, there is provided a novel dual-port showerhead for use in recirculating showers.

### SUMMARY

The present disclosure is directed towards a method and system that, in one embodiment, provides a solution for recirculating showers to comply with both low-flow efficiency standards and building code requirements around back-flow prevention all while maintaining continuous water flow.

The disclosure includes a dual-port showerhead for receiving water from two independent water sources allowing the water to flow through and never mixing. In one embodiment, one of the ports receives fresh grid supplied water originating from the household domestic grid supply and the second port receives and enables recycled, or recirculated, water to enter and exit the showerhead. In one embodiment, the recycled or recirculated water originates from a point-of-use recirculating shower device. Due to the recovery and multi-use nature of this water source, it may be permitted to flow at an increased flow rate that exceeds low-flow limitations.

In one aspect of the disclosure, there is provided a dual-port showerhead including a set of openings for receiving water from a first water supply and a second water supply; a set of water supply collection cavities, each of the set of water supply collection cavities associated with one of the set of openings; and a barrier separating each of the set of water supply collection cavities such that water from the first water supply and the second water supply do not mix.

In another aspect, the first water supply is a fresh grid water supply and the second water supply is a recirculated water supply. In a further aspect, the set of water supply collection cavities includes a first water supply collection cavity connected to the first water supply and a second water supply collection connected to the second water supply. In yet another aspect, the showerhead includes a first set of nozzles connected to the first water supply connection cavity; and a second set of nozzles connected to the second water supply collection cavity. In yet a further aspect, the second set of nozzles are larger than the first set of nozzles.

In another aspect, the barrier includes a tri-layer gasket. In a further aspect, the tri-layer gasket includes a pair of “O” rings. In yet another aspect, the showerhead further includes a top plate; a gasket layer; and a bottom plate. In a further aspect, the top plate includes the set of a set of openings for receiving water from the first water supply and the second water supply. In yet a further aspect, the gasket layer includes the barrier for separating and defining the set of water supply collection cavities. In yet another aspect, the showerhead further includes a set of nozzles for delivering water from the first and second water supplies out of the showerhead. In yet another aspect, the set of nozzles includes a first set of nozzles for delivering water from the first water supply; and a second set of nozzles for delivering water from the second water supply. In a further aspect, the first set of nozzles delivers water at a first flow rate and the second set of nozzles delivers water at a second flow rate. In another aspect, the first flow rate is lesser than the second flow rate. In yet another aspect, the barrier includes a gasket or a physical divider.

### BRIEF DESCRIPTION OF THE DRAWINGS

Embodiments will now be described, by way of example only, with reference to the attached drawings, in which:

FIG. 1 is a schematic diagram of one embodiment of a recirculating shower system;

FIG. 2a is a top view of a dual-port showerhead in accordance with an embodiment of the disclosure;

FIG. 2b is a bottom perspective view of the dual-port showerhead of FIG. 2a;

FIG. 2c is bottom view of another embodiment of a dual-port showerhead;

FIG. 3a is a schematic side view of a dual-port showerhead;

FIG. 3b is a schematic top view of a dual-port showerhead;

FIGS. 3c to 3i are schematic views of different dual-port orientations;

FIG. 4a is an exploded view of a dual-port showerhead;

FIG. 4b is a top perspective view of a top plate of FIG. 4a;

FIG. 4c is a top perspective view of a middle plate of FIG. 4a;

FIG. 4d is a top perspective view of a bottom plate of FIG. 4a;

FIG. 4e is a photograph of another embodiment of top and middle plates; and

FIG. 5 is a photograph of water flowing from one of the showerhead ports.

### DETAILED DESCRIPTION

The disclosure is directed at a dual-port showerhead and method of fabrication. In one embodiment, the showerhead is used in a recirculating shower. In another embodiment, the dual-port showerhead includes two inlet ports that receive water from independent water supplies such that the water flows from the independent water supplies are separated from each other within the showerhead. In one embodiment, a first water supply may be a main waterline, or grid supplied water source, while a second water supply may be a reservoir of collected shower water that is to be recirculated. The reservoir may be located under a shower to collect the shower water.

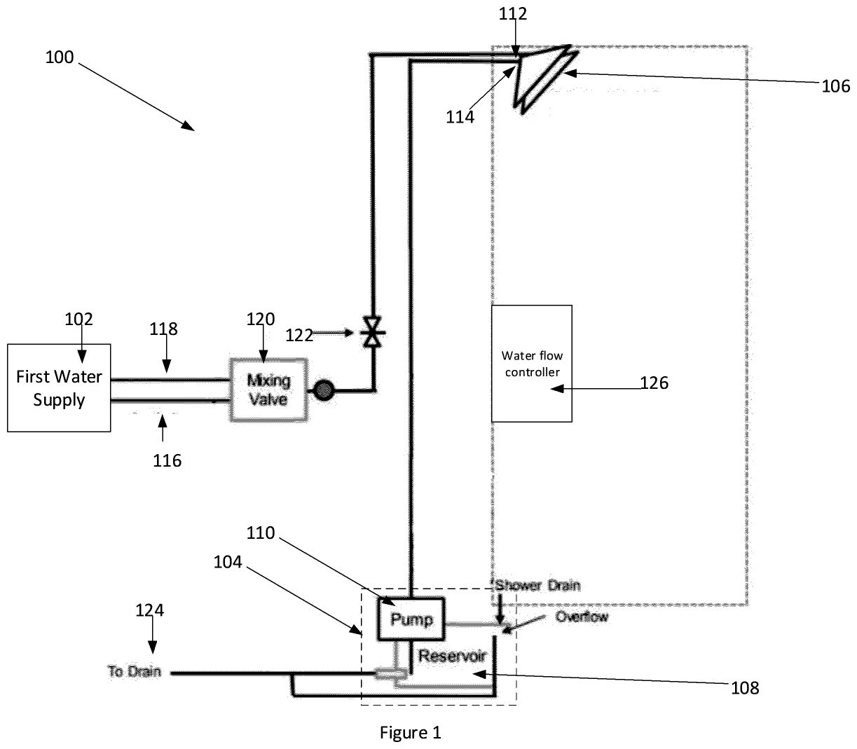

Turning to FIG. 1, a schematic diagram of one embodiment of a recirculating shower is shown. A dual-port showerhead in accordance with the disclosure is installed within the recirculating shower.

The recirculating shower 100 includes a first water supply 102, which may be a seen as a grid water supply, and a second water supply 104, which may be seen as a recirculating water supply, connected to a showerhead 106. In the current embodiment, the second water supply 104 includes a reservoir 108 for collecting shower water and a pump 110 for pumping the water from the reservoir 108 to the showerhead 106. In some embodiments, the pump 110 is either located directly above or mounted to the reservoir 108.

The first water supply 102 and the second water supply 104 are connected to separate ports within the dual-port showerhead 106 with the first water supply 102 connected to a first port 112 of the showerhead 106 and the second water supply 104 connected to a second port 114 of the showerhead 106. The dual ports separate the two water paths and enable the two water paths to be controlled such that they may exit at different rates or pressures. This is described in more detail below.

The first water supply 102 may include a hot water line 116 and a cold water line 118 that are connected to a mixing valve 120 that enables the water from the two water lines to be mixed in accordance with a desired temperature requested by an individual taking a shower. This mixing valve may be mechanically or electronically controlled. Temperature and flow control of water from the first water supply 102 will be understood by one skilled in the art. The water from the mixing valve 120 may pass through a solenoid valve 122 before entering the showerhead 106. The shower system may also include a flow restrictor (not shown).

For the second water supply 104, the collected shower water is stored in the reservoir 108 and then pumped up to the showerhead 106 via the pump 110. In one embodiment, the reservoir 108 is located within a basin or space underneath the shower to collect water from the shower. Any overflow from the reservoir 108 may be self-regulated to exit through a drain 124 to a sewer system as with a common shower. If a blockage or plug exists in the recirculation line, a user can switch over to the first water supply, or grid supplied fresh water supply, until the line is cleared. Characteristics of the water flow from the second water supply 104 may also be controlled.

The shower 100 further includes a water flow controller 126 that allows a user to determine which water supply to use, a temperature of the water being supplied and/or a flow rate of the water being supplied.

In use, an individual taking a shower may decide which water supply they wish to use via the water flow controller 126. In one embodiment, the water flow controller 126 may be a combination of a switch to select between the first and second water supplies and a tap for controlling the temperature and pressure of the water. In another embodiment, the water flow controller may be a digital control that enables the user to select the water supply along with the water flow characteristics. The shower system then supplies water in accordance with the selections made by the individual, and passes the water through the pipes to the showerhead 106 where the water exits the showerhead so that the individual may take a shower or rinse. The individual may also change the water supply during the shower whereby the shower system reacts accordingly to change water supplies. In another scenario, the individual may choose to have water supplied by both the first and second water supplies concurrently.

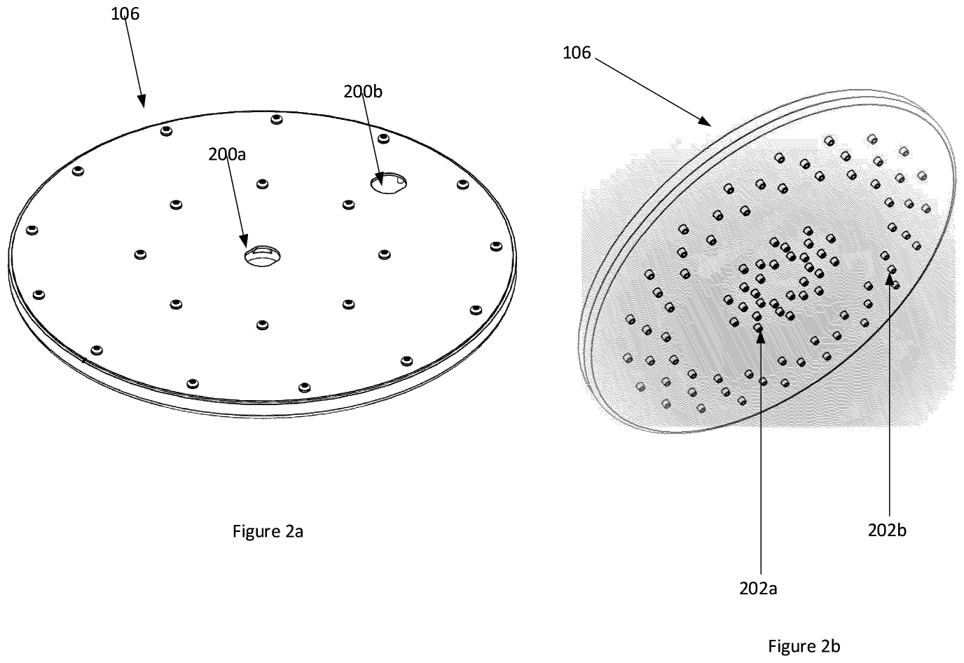

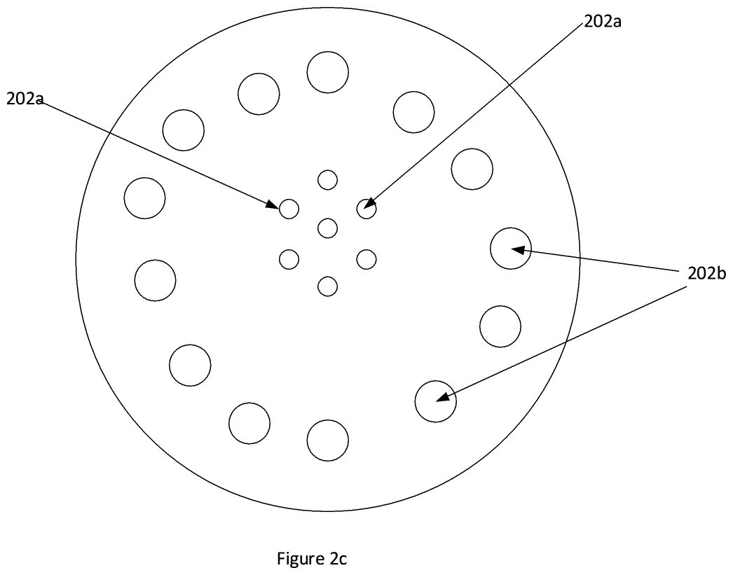

Turning to FIGS. 2a to 2b, top and bottom perspective views of a dual-port showerhead in accordance with the disclosure are shown. As can be seen in FIG. 2a, the showerhead 106 includes a pair of openings 200a and 200b which may be connected to the first water supply 102 and the second water supply 104, respectively. Opening 200a may be seen as a first water supply port opening and opening 200b may be seen as a second water supply port opening. It is understood that the openings 200 may include a fastening apparatus, such as, but not limited to, a locking collar, a quick-lock portion or a threaded portion, enabling the openings 200 to be connected to the water supplies. The water may be delivered from the water supplies via a set of pipes, the pipes having connects at one end to mate with the fastening apparatus in the openings 200. The openings 200 are associated with individual and distinct ports within the showerhead such that the water from the different water supplies do not mix within the showerhead 106.

As can be seen in FIG. 2b, the showerhead 106 includes a set of nozzles 202 through which the water exits the showerhead 106 into the shower. The set of nozzles may include a set of first water supply nozzles 202a and a set of second water supply nozzles 202b. In some embodiments, the set of first water supply nozzles 202a and the set of second water supply nozzles 202b may be the same size and in other embodiments, they may be different sizes where one set of nozzles is able to handle a higher flow rate than the other set of nozzles. The size of the nozzles 202 may be designed such that the showerhead operates in accordance with regulatory body requirements. Also, the positioning of the nozzles may be changed without affecting the scope of the disclosure. The shape, size and/or cross-section of the set of nozzles may also be determined based on shower requirements.

In a specific embodiment, such as shown FIG. 2c, the set of second water supply nozzles 202b are larger in diameter than the set of first water supply nozzles 202a to comply with showerhead regulations. The larger nozzles (or the set of second water supply nozzles 202b) allow for a more forceful water flow compared with the water flow that is possible with the smaller first water supply nozzles 202a. One advantage of the larger sized nozzles is that since the recirculated water supplied to the second water supply nozzles may include dissolved particulates, the larger sized nozzles may reduce the likelihood of blockage by these particulates due to their size and ability to allow a large volume or recirculated water to pass though unobstructed and/or without clogging.

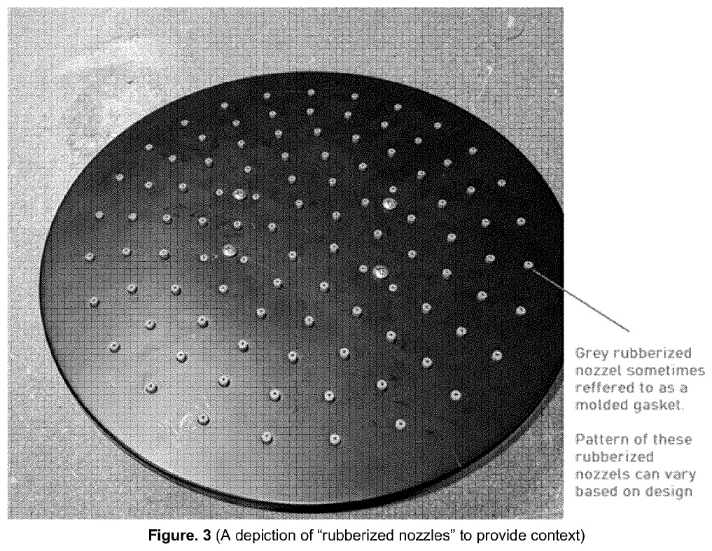

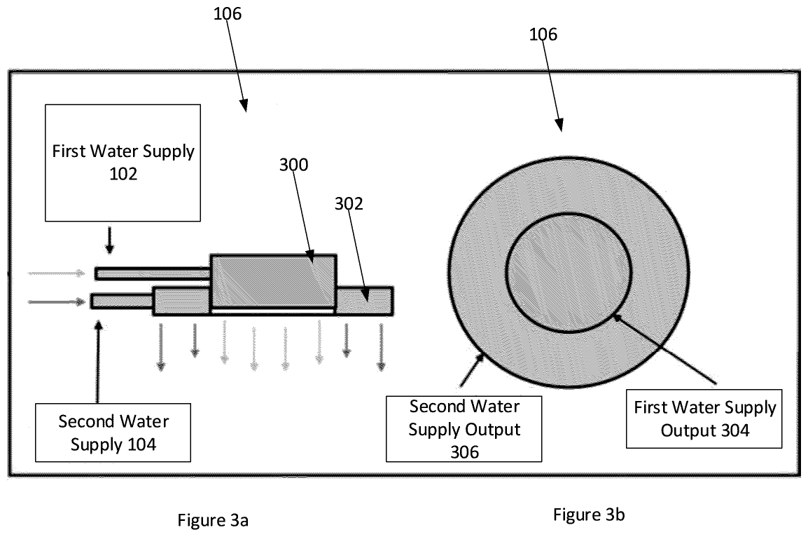

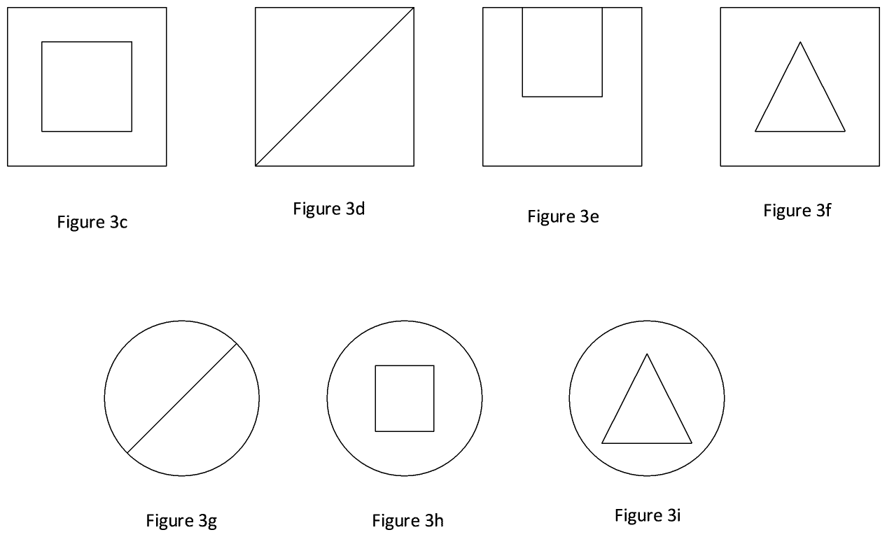

Turning to FIGS. 3a and 3b, a schematic side view and a schematic top view of a general embodiment of the showerhead are provided. As shown in FIG. 3b, the showerhead 106 includes a pair of showerhead water reservoirs or collection areas, seen as a first water supply collection cavity 300 and a second water supply collection cavity 302. The water from the first water supply 102 exits the showerhead 106 via the first water supply outlet 304. The first water supply is connected to, or associated with, the first water supply collection cavity 300 via opening 200a. In this embodiment, the first water supply may be as a fresh grid water supply. The second water supply 104 is connected to, or associated with, the second water supply collection cavity 302 via the second opening 200b. The water from the second water supply 104 exits the showerhead 106 via the second water supply outlet 306. In this embodiment, the second water supply 104 may be seen as a recirculated water supply. In some embodiments, one of the collection cavities may be seen to provide a high flow water stream, while the other water supply collection cavity may be seen as providing a low-flow water stream.

In the current embodiment, the first water supply collection area 300 is a circular collection cavity and the second water supply collection cavity 302 is a ring. In other embodiments, positioning of the first and second water supply collection cavities may be switched such that the first water supply collection cavity surrounds the second water supply collection cavity. It is understood that other shapes may be contemplated and that the reservoirs or collection cavities may be placed, or oriented, differently such as, but not limited to, adjacent each other. Different showerhead port configurations are shown in FIGS. 3c to 3i.

FIG. 3c is an embodiment where the showerhead is a square shape and where both water supply collection cavities are square in shape (although they may also be rectangular) with one water supply collection cavity located or positioned within the other water supply collection cavity. FIG. 3d is an embodiment where the showerhead is a square shape and both water supply collection cavities are triangular in shape and adjacent each other. FIG. 3e is an embodiment where the showerhead is a square shape and both water supply collection cavities have a square shape with one water collection cavity surrounding three edges of the other water supply collection cavity. FIG. 3f is an embodiment where the showerhead is a square shape and one water supply collection cavity is triangular in shape and the other one is square in shape and surrounds the triangular water supply collection cavity. FIG. 3g is an embodiment where the showerhead is circular in shape and both water supply collection cavities are semi-circular in shape and are adjacent each other. FIG. 3h is an embodiment where the showerhead is circular in shape with one water supply collection cavity being square in shape and surrounded by the other water supply collection cavity that is circular. FIG. 3i is an embodiment where the showerhead is circular in shape where one water supply collection cavity has a triangular shape that is surrounded by the other water supply collection cavity that is circular. In some embodiments, the showerhead may be a two-piece showerhead where the water supply collection cavity associated with the fresh water supply may be connected to a handle such that it can be detached from the showerhead to provide a hand-held shower appliance such as with some current shower appliances.

As shown in FIG. 3a, which is a schematic side view of an embodiment of a showerhead, the dual port nature of the showerhead can be seen. Fresh water (such as from the first water supply 102) enters the central first water supply collection cavity 300 while the recirculated water (from the second water supply 104) enters the outer ring, or outer portion (the second water supply collection cavity 302) of the showerhead. The showerhead keeps the water from the two supplies separated such that they do not mix when inside the showerhead.

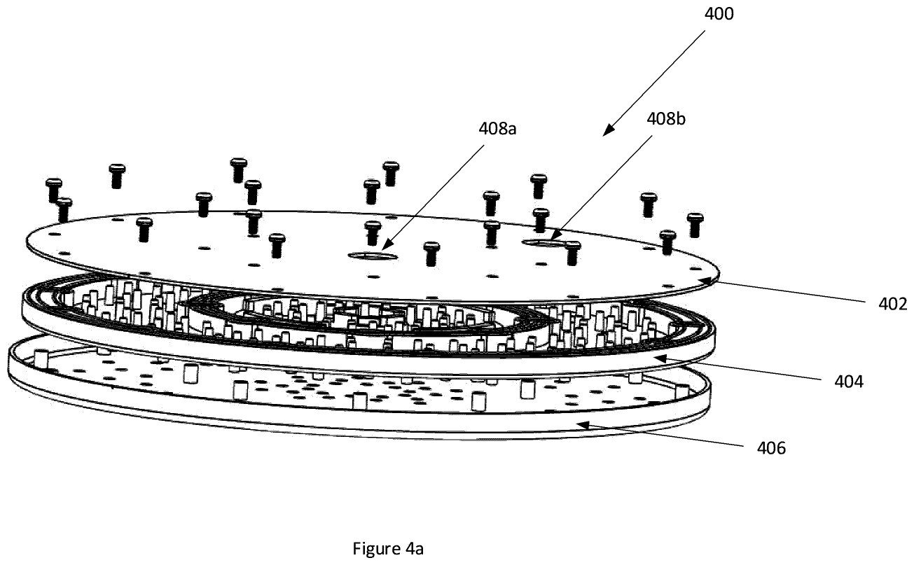

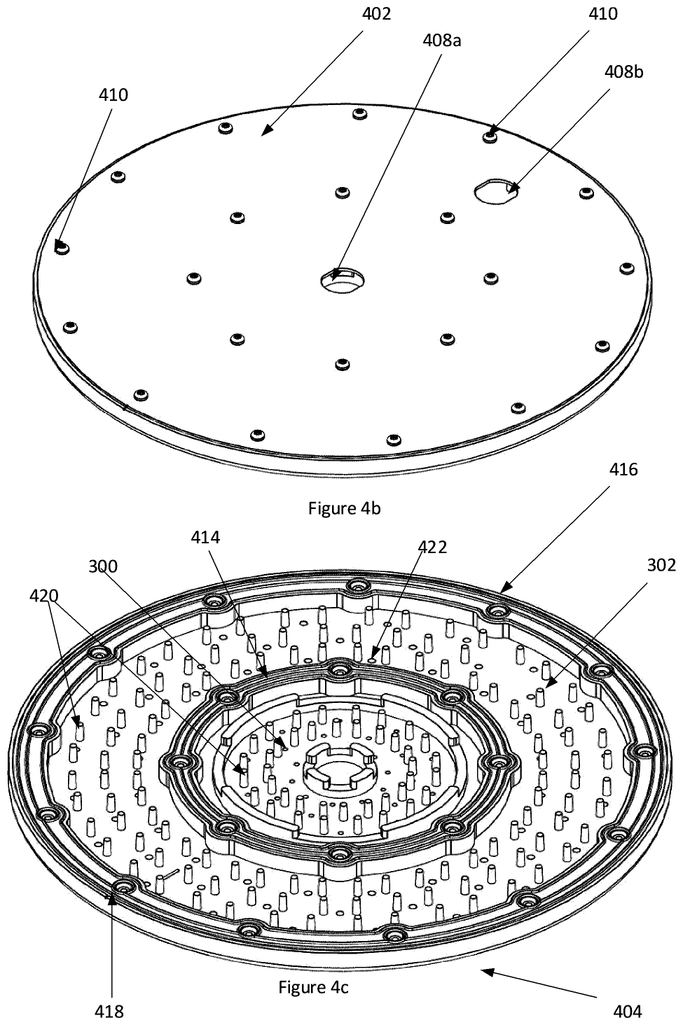

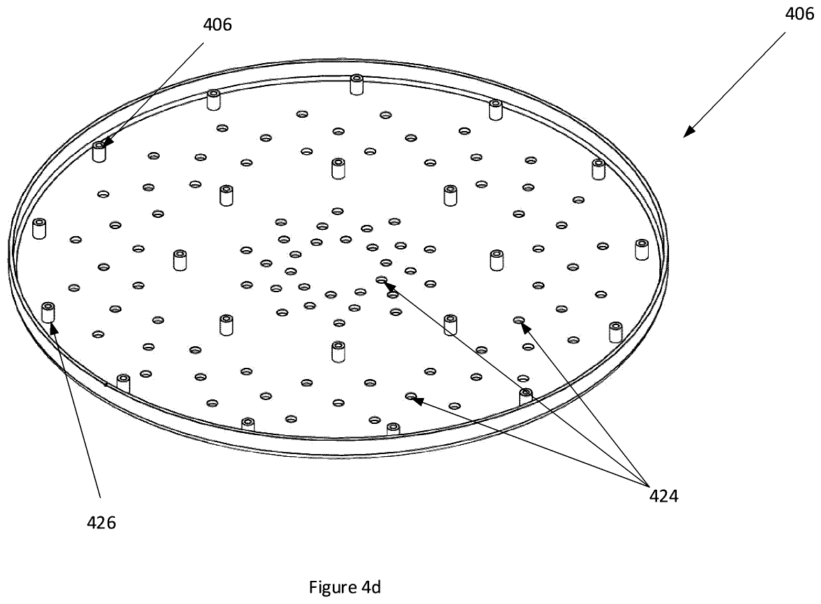

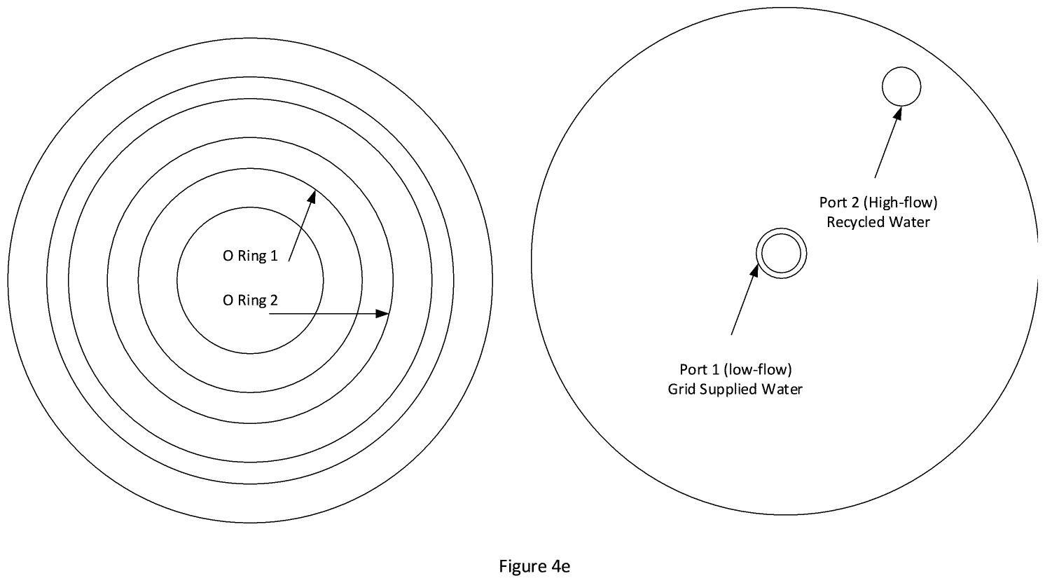

Turning to FIG. 4a, a side view of the separate components of one embodiment of a dual-port showerhead is shown. In the current embodiment, the showerhead 400 includes a top plate or layer 402, a middle gasket or layer 404 and a bottom plate or layer 406. The top plate 402 includes openings 408a and 408b (similar to openings 200a and 200b) for receiving water from separate water supplies, which may be seen as a first water supply and a second water supply. Examples of water supplies are discussed above. Although not shown, the openings 408 include fastening apparatus enabling the showerhead to be connected to the piping associated with the different water supplies. The fastening apparatus may be a threaded collar, a locking collar or a quick-lock collar.

As shown in FIG. 4b, which is a perspective view of the top plate, the top plate 402 further includes a set of holes 410 for receiving fasteners, such as, but not limited to, screws, to connect or integrate the top 402 plate, middle gasket 404 and bottom plate 406.

As shown in FIG. 4c, which is a perspective view of the middle gasket, the middle gasket 404 includes a pair of separate sections 412a and 412b (which represent the water supply collection cavities 300 and 302 respectively, as discussed above) that are each associated with one of the openings 408. The sections are separated from each other by a barrier 414. The barrier may be seen as a gasket or a physical divider. In the current embodiment, the barrier 414 is a tri-layer gasket that separates the two sections 412a and 412b. This may be seen as a triple ring barrier embodiment. An outer ring gasket 416 is also present to keep the water within the showerhead when assembled and in use. Both gasket ring barriers 414 and 416 include holes 418 that are aligned with the holes 410 in the top plate 402 to receive the fasteners for fastening the plates or layers together. In some embodiments, the gaskets may be removable so that they may be cleaned.

In another embodiment, the barrier 414 may include a pair of “O” rings made of the same material as the middle gasket 404. Therefore, when the layers are all connected, the gasket 414 causes the water from the two different water supplies to be separated from each other also understood as being hydraulically disconnected from each other. FIG. 4e is a photograph showing another embodiment of top and bottom middle plates.

In another embodiment, the barrier 414 may be a single “O” ring with a predetermined thickness. In a further embodiment, the barrier is any type of structure or combination of parts that maintain separation of the water in the two water supply collection cavities from each other. For examples, in embodiments where the water supply collection cavity is not circular, an “O” ring may not be used.

In another embodiment, the collection cavities separating the water from the first water supply 102 and the water from the second water supply may be completely separate from each other without a middle gasket 404 such as where the dual-port showerhead includes two distinct but associated showerheads.

In the current embodiment, the inner circular section 300 or annulus supplies fresh grid supplied water independent of the water supplied by the outer circular section 302 of the showerhead 400. As discussed above, although the pair of sections 412 are shown as being circular in the current embodiment, the sections may be differently shaped and/or differently positioned such as schematically shown in FIGS. 3c to 3i. One advantage of the current disclosure is that the dual-port showerhead avoids or reduces the likelihood that water from the independent sources (the first and second water supplies) touch or mix prior to being discharged from their unique rubberized nozzles within the showerhead. Also, by separating the water flows, the water from each water supply may flow at different and independent flow rates in order to comply with showerhead regulations.

As further shown in FIG. 4b, each of the sections 412 includes a set of separation spacers or pegs 420 that help to direct the flow of water towards holes, or openings 422 that allow the water to pass from through the middle gasket 404 to exit the showerhead. The separation spacers 420 may also maintain an equally sized gap between the upper and lower plates. In some embodiments, the holes 422 may be aligned with a set of nozzles in the bottom plate that enable the water within each section to exit the showerhead under the pressure supplied via the water supplies. In in other embodiments, the holes 422 receive one end of the nozzles such that the water passes through the middle gasket and directly out of the showerhead and a portion of the nozzles extend through the hole 422 into the space between the top plate and the middle gasket. In another embodiment, the top of each nozzle may be flush with a surface of the middle gasket. In some embodiments, the set of nozzles may be a distinct component and may be installed or inserted into the holes 422 of the middle gasket 404. In other embodiments, the set of nozzles and the middle gasket may be formed of the same material such as via an injection moulding process.

In use, the flow rate at which the water exits the showerhead is somewhat controlled by the pressure that the water is supplied to the showerhead. The pressure may be determined via the water flow controller, an installed flow restrictor or may be determined remotely, such as by the domestic water supply. In some embodiments, the pressure at which the recirculated water is supplied may be controlled by the pump.

As shown in FIG. 4d, which is a perspective view of the bottom plate, the bottom plate 406 includes a set of holes 424 that allow the water to exit the showerhead. Although not shown, each of the set of holes is associated with, or designed to receive, a nozzle. The bottom plate 406 further includes a set of pegs 426 for receiving the fasteners discussed with respect to holes 410 in the top plate 402 and holes 418 in the middle layer 404.

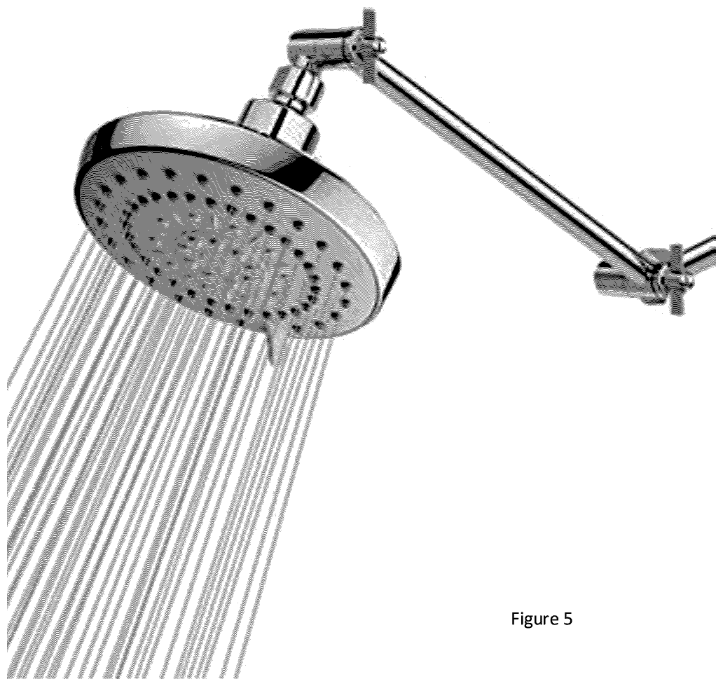

In use, the flow of water to and out of the showerhead is controlled by a user via know methods such as a water flow controller. For example, the first water supply (or water from the fresh water grid) or the second water supply (or recirculated water) may be controlled by a tap within the shower. Control of the water flow may also be via a digital control that may allow the user to select a temperature and/or flow of water. For the first water supply, the temperature of the water flow may be controlled by mixing the hot and cold water flows via the mixing valve. Alternatively, the hot and cold water flows may travel through a common pressure regulating or thermostatic mixer before traveling through a solenoid valve which regulates ON/OFF flow. For the second water supply, as the recirculated water is pumped by the pump from the reservoir to the showerhead, the recirculated water may be passed through a heating or cooling apparatus to provide the recirculated water at the requested temperature. Both water supplies flow into the showerhead via the opening to which their piping is connected. After the supplied water enters one of the two ports of the showerhead, the water then exits the showerhead via the set of nozzles. FIG. 5 is a photograph of water flowing from one of the water supply collection cavities.

If the user decides to change the water supply source mid-shower, the water flow from the initially selected water supply is stopped and water is then supplied by the other water supply to the other of the two ports of the showerhead which then supplies the water to the shower. In other embodiments, a user may manually switch from using one flow path or water source to the other or may decide to use water from both flow paths in tandem, however, the water from both flows remains separated until they exit their respective nozzles.

The dual-port showerhead allows users to conserve fresh water by using recirculated water when there is a simple need to relax and enjoy a higher flow experience but not unnecessarily waste water. Also, the dual-port showerhead may allow the flow of water from the different supplies to be delivered at different pressures based on general shower and shower water regulations. Another advantage of the disclosure is the avoidance of two separate showerheads being installed to hydraulically separate the water sources (one for the fresh water supply and one for the recirculation water supply).

In another example of use of the disclosure, if a user would like to transition from using fresh grid supplied water at low pressure to a higher spa like experience using water from the recirculation water supply at higher pressure, the transition may occur without the inconvenience of changing showerheads, feeling intermittently cold or shifting body position. In one embodiment, the current disclosure allows a recirculating shower to begin the pumping of water from the reservoir tank to the recycled water flow port located at the back of a dual-port showerhead so that there is a continuous flow of water through the single showerhead as the transition between the two water supplies takes place. Alternatively, the water flow paths can be operated simultaneously never leaving the user feeling cold and with water being delivered from one showerhead at two different pressures simultaneously

In another embodiment, the shower system may include at least one sensor that automatically facilitates the transition between the two water supply sources. Example sensors may include, but are not limited to, temperature sensors, proximity sensors or infrared sensors.

Although the present disclosure has been illustrated and described herein with reference to various embodiments and specific examples thereof, it will be readily apparent to those of ordinary skill in the art that the elements of the embodiments may be combined in other ways to create further embodiments and also other embodiments and examples may perform similar functions and/or achieve like results. All such equivalent embodiments and examples are within the spirit and scope of the present disclosure as defined by the claims.

In the preceding description, for purposes of explanation, numerous details may be set forth in order to provide a thorough understanding of the embodiments. However, it will be apparent to one skilled in the art that these specific details may not all be required. In other instances, well-known structures may be shown in block diagram form in order not to obscure the understanding.

What is claimed:

1. A dual-port showerhead comprising:
a set of openings for receiving water from a first water supply and a second water supply;
a set of water supply collection cavities, each of the set of water supply collection cavities associated with one of the set of openings; and
a barrier separating each of the set of water supply collection cavities such that water from the first water supply and the second water supply do not mix.

2. The dual-port showerhead of claim 1 wherein the first water supply is a fresh grid water supply and the second water supply is a recirculated water supply.

3. The dual-port showerhead of claim 1 wherein the set of water supply collection cavities comprises a first water supply collection cavity connected to the first water supply and a second water supply collection connected to the second water supply.

4. The dual-port showerhead of claim 3 further comprising:
a first set of nozzles connected to the first water supply connection cavity; and
a second set of nozzles connected to the second water supply collection cavity.

5. The dual-port showerhead of claim 4 wherein the second set of nozzles are larger than the first set of nozzles.

6. The dual-port showerhead of claim 1 wherein the barrier comprises a tri-layer gasket.

7. The dual-port showerhead of claim 6 wherein the tri-layer gasket comprises a pair of “O” rings.

8. The dual-power showerhead of claim 1 further comprising:
a top plate;
a gasket layer; and
a bottom plate.

9. The dual-port showerhead of claim 8 wherein the top plate comprises the set of a set of openings for receiving water from the first water supply and the second water supply.

10. The dual-port showerhead of claim 9 wherein the gasket layer comprises the barrier for separating and defining the set of water supply collection cavities.

11. The dual-port showerhead of claim 10 further comprising a set of nozzles for delivering water from the first and second water supplies out of the showerhead.

12. The dual-port showerhead of claim 11 wherein the set of nozzles comprise:
a first set of nozzles for delivering water from the first water supply; and
a second set of nozzles for delivering water from the second water supply.

13. The dual-port showerhead of claim 12 wherein the first set of nozzles delivers water at a first flow rate and the second set of nozzles delivers water at a second flow rate.

14. The dual-port showerhead of claim 13 wherein the first flow rate is lesser than the second flow rate.

15. The dual-port showerhead of claim 1 wherein the barrier comprises a gasket or a physical divider.
